(19) United States
(12) Patent Application Publication
(10) Pub. No.: US 2014/0203709 A1
(43) Pub. Date: Jul. 24, 2014

(54) LED Driver Circuit

(71) Applicant: INFINEON TECHNOLOGIES AUSTRIA AG, Villach (AT)

(72) Inventor: Bernd Pflaum, Unterhaching (DE)

(73) Assignee: Infineon Technologies Austria AG, Villach (AT)

(21) Appl. No.: 13/748,409

(22) Filed: Jan. 23, 2013

(51) Int. Cl. H05B 37/02

(52) U.S. Cl. CPC H05B 37/0227
USPC 315/127

(57) ABSTRACT

A semiconductor chip includes an LED driver circuit operably coupled to at least one LED and configured to supply a load current to the at least one LED such that an average load current matches a desired current level defined by a drive signal. A temperature measurement circuit is thermally coupled to the LED driver circuit or the LED(s) or both, and is configured to generate, as drive signal, a temperature dependent signal in such a manner that the drive signal is approximately at a higher constant level for temperatures below a first temperature, is approximately at a lower constant level for temperatures above a second temperature but below a maximum temperature, and continuously drops from the higher constant level to the lower constant level for temperatures rising from the first temperature to the second temperature.

### TECHNICAL FIELD

The present description relates to circuits and methods for driving light emitting diodes (LEDs), particularly to circuits and methods for driving LEDs including an over temperature protection.

### BACKGROUND

Light emitting diodes (LEDs) are becoming increasingly popular as energy-saving substitute for incandescent lamps in various applications. Unlike incandescent lamps LEDs are current-driven components and as such require driver circuits including a load current regulation. In order to reduce power dissipation within the driver circuits switched mode power supplies are usually employed to supply a LED or a series circuit of several LEDs (also referred to as LED chain) with a well-defined load current. Generally, the resulting luminous intensity (usually measured in candela) is directly proportional to the load current. The power dissipation within the driver circuit (even when including a switching converter) may, however, still become a problem which—if no security mechanism is included—may result in a thermal destruction of the driver circuit, particularly of the power stages included therein. Not only the power stages of the LED driver but also the LEDs themselves are at risk to overheat.

For this purpose many LED driver devices (including an integrated driver circuit) include a sense terminal (i.e., a chip pin) to which an external temperature sensor may be attached (usually as an option). For example, the high power white LED driver STCF02 of STM (see STMicroelectronics, data sheet STCF02, February 2007) provides a chip pin for connecting an NTC temperature sensor which is a temperature dependent resistor (thermistor) having a negative temperature coefficient (NTC). The external temperature sensor is usually used to trigger a shut-down of the device when a critical temperature has been detected.

However, in security relevant applications (e.g., the illumination of emergency exits, escape routes, emergency shut-down switches, etc.) a simple shut-down of the LED driver is insufficient as maintaining the illumination is essential. Furthermore, also in non-security related applications reliability (even in hot environments or where sufficient cooling is problematic) may also be a desired feature of an illumination device including a LED driver and respective LEDs. Finally, it is desirable to reduce the required external components necessary to operate the LED driver and to protect the driver as well as the LEDs. The still required external components should be inexpensive and easy in integrate into an illumination device.

Thus there is a need for improved LED driver circuits that are easy to use and include an intelligent over-temperature protection.

### SUMMARY OF THE INVENTION

A semiconductor chip including integrated circuitry for driving LEDs is described. In accordance with one example of the invention the circuit comprises a LED driver circuit operably coupled to at least one LED and configured to supply a load current to the at least one LED such that an average load current matches a desired current level determined by a drive signal. A temperature measurement circuit is thermally coupled to the LED driver circuit and configured to generate, as drive signal, a temperature dependent signal in such a manner that the drive signal is approximately at a higher constant level for temperatures below a first temperature, approximately at a lower constant level for temperatures above a second temperature but below a maximum temperature, and continuously drops from the higher constant level to the lower constant level for temperatures rising from the first temperature to the second temperature.

### BRIEF DESCRIPTION OF THE DRAWINGS

The invention can be better understood with reference to the following drawings and descriptions. The components in the figures are not necessarily to scale, instead emphasis is placed upon illustrating the principles of the invention. Moreover, in the figures, like reference numerals designate corresponding parts. In the drawings:

FIG. 1a illustrates an exemplary LED driver circuit including a buck converter for driving a LED, the load current being supplied to the LED depends on a temperature dependent drive signal;

FIG. 1b illustrates another exemplary LED driver circuit which provides a modulated load current to a LED, the average load current (which determines the luminous intensity) corresponds to a duty cycle which is set in accordance with a temperature dependent drive signal;

FIG. 1c illustrates a circuit that includes a temperature measurement circuit, an LED driver and an LED;

FIG. 2 illustrates one exemplary ensemble of characteristic curves representing the temperature dependency of the drive signal;

FIG. 3 illustrates one abstract exemplary of the characteristic curve of FIG. 2 including the parameters that determine the characteristic curve; and

FIG. 4 illustrates one exemplary temperature measurement circuit configured to generate the drive signal in accordance with the characteristic curve of FIG. 2.

### DETAILED DESCRIPTION OF ILLUSTRATIVE EMBODIMENTS

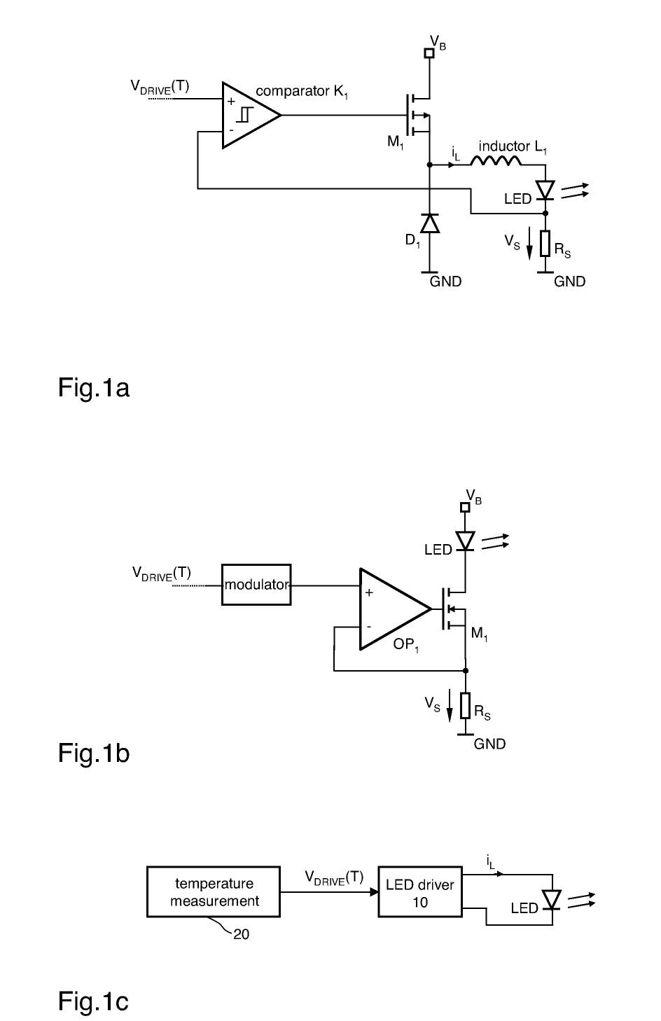

FIG. 1, which includes FIGS. 1a-1c, illustrates difference examples of LED driver circuits. In the example of FIG. 1a the driver circuit includes a switching converter (precisely, a buck converter) whereas, in the example of FIG. 1b, the driver circuit includes a modulator MOD to provide a modulated load current to the LED. The modulator MOD may be any common on/off-modulator such as a pulse width modulator (PWM), a pulse frequency modulator (PFM), a sigma-delta modulator or the like.

The circuit of FIG. 1a includes a first semiconductor switch, which is implemented as a MOS transistor M₁, and a second semiconductor switch, which is implemented as a silicon diode D₁. The MOS transistor M₁ and the diode D₁ are connected in series between a first supply terminal supplied with a first supply potential V_{B} and a second supply terminal GND supplied with a second supply potential, e.g., ground potential VGND. The MOS transistor M₁ and the diode D₁ form a kind of a half bridge wherein the common circuit node of the transistor M₁ and the diode D₁ is the half-bridge output node at which the load current iL is provided. The LED is connected to that half-bridge output node via an inductor L1. As such a first inductor terminal is connected to the half-bridge output node whereas a second inductor terminal is connected to the anode of the LED. The cathode of the LED is coupled to the second supply terminal GND via a current sensing resistor RS such that LED, inductor L1 and resistor RS form a series circuit. The voltage drop V_{S} across the resistor RS is representative of (in the present example proportional to) the load current iL passing through the LED. A comparator K1 with hysteresis receives the a temperature dependent drive signal VDRIVE(T) and the voltage drop V_{S} representing the load current iL. The output of the comparator K1 is coupled to the gate of the MOS transistor M₁, e.g., via a designated gate driver circuit (not shown).

When voltage V_{S}=R_{S}·i_{L} falls below the lower threshold VDRIVE-ΔV, the output of the comparator K₁ drives the MOS transistor M₁ into an on-state in which the load current i_{L} passes from the first supply terminal to the second supply terminal GND via the MOS transistor M₁, the inductor L1, the LED, and the sense resistor RS. In this case the diode D₁ is reverse biased. When the voltage V_{S}=R_{S}i_{L} exceeds the higher threshold V_{DRIVE}+ΔV, the output of the comparator K₁ drives the MOS transistor M₁ into an off-state in which—due to the self-inductance of the inductor L₁—the load current i_{L} passes from the second supply terminal GND via the diode D₁ (which is then forward biased), the inductor L₁, the LED, and the sense resistor RS back to the second supply terminal GND. As a result, the average load current i_{AVG} corresponds to V_{DRIVE} (i.e., V_{AVG}=V_{DRIVE}/R_{S}) whereas the peak-to-peak value of the ripple current is 2·ΔV. It should be noted that the LED driver circuit illustrated in FIG. 1a has to be regarded as an example. The MOS transistor M₁ may be replaced by any other type of transistor, the diode D₁ may be substituted by an adequately driven transistor. The LED is coupled to the low side of the circuit. However, the LED may also be placed in a high-side configuration.

FIG. 1b illustrates another exemplary driver circuit which does not require an inductor. In the present example the LED is connected in series with the load current path of a transistor M₁ (e.g., the drain-source current path in case of a MOSFET) and a current sense resistor RS. The total supply voltage (V_{B}−V_{GND}) is applied to this series circuit. In the present example the load current iL passes from the first supply terminal (which is supplied with the first supply potential V_{B}) via the LED, the transistor's load current path, and the resistor RS to the second supply terminal GND which is supplied with a second supply potential V_{B}, e.g., ground potential. The instantaneous load current value is dependent on the conduction state of the transistor M₁. As in the previous example, the voltage drop V_{S} (sense signal) across the sense resistor RS represents the load current iL wherein the voltage drop V_{S} equals R_{S}i_{L}. In the current example, the transistor M₁ is driven by an operational amplifier whose output is coupled to the gate of the transistor M₁ (e.g., via a designated gate driver, not shown). The operational amplifier OP₁ is supplied with the sense signal V_{S} and a corresponding reference signal V_{M}. It operates as a P-regulator which regulates the load current i_{L} (by appropriately controlling the conductance of the transistor M₁) such that the sense signal V_{S} approximately equals the reference signal V_{M}, which is tantamount to i_{L}=V_{M}/R_{S}. That is, the load current is regulated to a value V_{M}/R_{S} corresponding to the reference signal V_{M}.

The reference voltage is usually an on/off-modulated signal having an amplitude and a variable duty cycle D, wherein Dε[0, 1]. As a result, the load current i_{L} passing through the LED will be correspondingly on/off-modulated. The average load current i_{AVG} (which determines the perceivable luminous intensity of the LED) is then i_{AVG}=i_{LON}·D wherein i_{LON} is the on-value of the load current i_{L} whereas its off-value is zero. The on/off-modulated signal VM is usually generated by a common analog or digital modulator which is configured to generate the on/off-modulated signal V_{M} and to set the duty cycle D to a value corresponding to a drive signal V_{DRIVE}. As in the previous example, the drive signal V_{DRIVE} is temperature dependent and indirectly determines the average load current i_{AVG} passing through the LED.

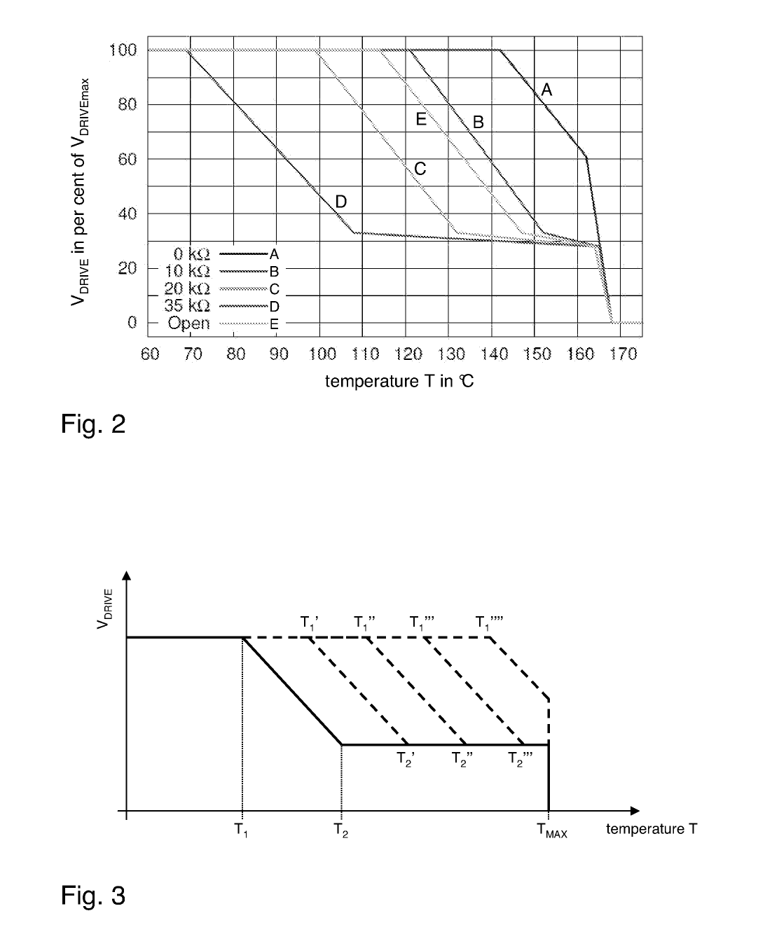

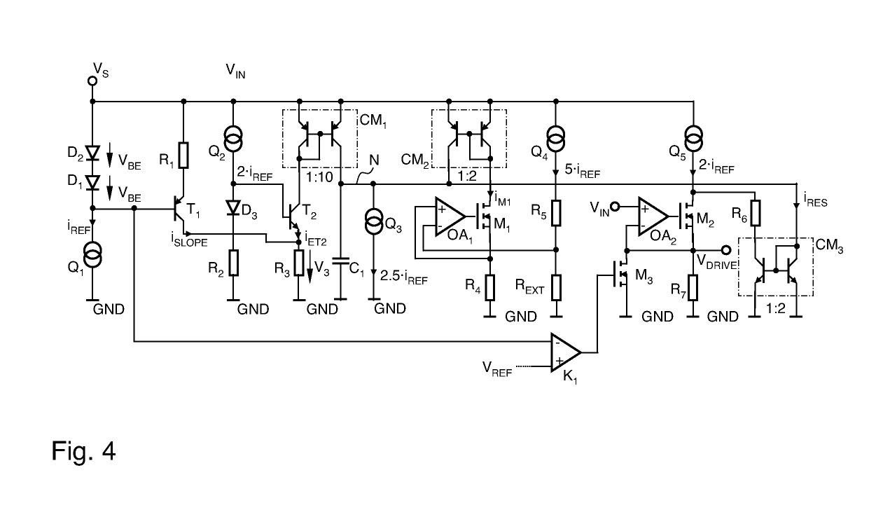

The general concept is summarized below with reference to FIG. 1c. A LED driver 10 is coupled to a LED (or a series circuit of LEDs) and configured to provide a load current i_{L} to the LEDs. The LED driver 10 generates the load current i_{L} in accordance with a drive signal V_{DRIVE} such that the average load current i_{AVG} matches the drive signal. Thus, the drive signal indirectly determines the average load current i_{AVG} and thus the luminous intensity of the LED. The drive signal is provided by a temperature measurement circuit 20 which generates the drive signal V_{DRIVE} such that it depends on temperature. The temperature dependency of the drive signal V_{DRIVE} follows some specific characteristic curve which is described further below with reference to FIGS. 2 and 3. The temperature measurement circuit 20, the LED driver circuit may be in close thermal contact. For example, both circuits 10, 20 may be included in one integrated circuit (IC) placed in one single chip package. A detailed example of the circuit 20 will be described further below with reference to FIG. 4. The circuit 20 usually includes an integrated temperature sensor such as, for example, a diode.

FIG. 2 illustrates a specific example of how the drive signal V_{DRIVE} depends on the temperature T. The diagram shown in FIG. 2 illustrates the drive voltage in percent of a maximum drive voltage level V_{DRIVEmax} which is provided at low temperatures, e.g., below 70° C. When a specific first temperature (further referred to as temperature T₁) is exceeded, the drive voltage V_{DRIVE} is reduced. The decrease of the drive voltage V_{DRIVE} continues as the temperature continues rising. The maximum drive voltage level V_{DRIVEmax} and the rate of the mentioned decrease (in volts per Kelvin) may be set by appropriate circuit design. When a specific second temperature (further referred to as temperature T₂) is exceeded, the drive voltage remains approximately constant or is further reduced at a much lower rate. In the present example, the drive voltage V_{DRIVE} stays at approximately 40 percent of the maximum level V_{DRIVEmax} for temperatures above 108° C. However, when the temperature still rises and exceeds a maximum temperature T_{MAX} then a thermal shut-down is initiated. In the present example T_{MAX} is approximately 160° C. The maximum temperature T_{MAX} may also be set by appropriate circuit design. The temperature measurement circuit 20 (see FIG. 1c) may be configured to allow the adjustment of the first temperature T₁ and the second temperature T₂ using an external component such as an external resistor. This allows integrating the temperature measurement circuit 20 and the driver circuit 10 (see FIG. 1c) into one single chip package and to allow the user to configure the temperature characteristic of the drive voltage V_{DRIVE} by attaching a single external resistor to one specific pin of the chip package.

FIG. 3 illustrates the temperature characteristic of the drive voltage on a more abstract level. The solid line illustrates one specific characteristic curve describing the behavior of the circuit 20, which provides the temperature dependent drive voltage V_{DRIVE}(T). Below a first temperature T₁ the drive voltage V_{DRIVE} approximately equals the maximum drive voltage level V_{DRIVEmax}. Above a second temperature T₂ the drive voltage V_{DRIVE} approximately equals the low drive voltage level V_{DRIVElow} provided that, however, the temperature remains below the maximum temperature T_{MAX} (T_{MAX}>T₂). A temperature equal to or higher than T_{MAX} triggers an over-current shut-down of the driver circuit. Between the first temperature T₁ and the second temperature T₂ the drive voltage drops approximately linearly. However, any other smooth or continuous transition between V_{DRIVEmax} and V_{DRIVElow} would be appropriate.

Reducing the drive voltage V_{DRIVE} at elevated temperatures (above T₁) entails a lower average load current passing through the LED resulting in a lower power dissipation in both, the driver circuit 10 as well as the LED(s). The lower power dissipation counteracts a further increase in temperature and may lead to a cooling-down of the LED and the driver circuit. However, the flat portion of the curve for temperatures T lower than T₁ ensures that the load current i_{L} and thus the perceivable luminous intensity is maintained on a constant desired level during normal operation in a pre-definable temperature range T<T₁. The gradual decrease of the drive voltage helps to reduce the dissipated power and thus reduces the risk of overheating. However, the perceivable luminous intensity is also reduced. The flat portion of the characteristic curve for high temperatures T>T₂ is provided to maintain a defined minimum luminous intensity (corresponding to a minimum drive voltage V_{DRIVEmin}), which is advantageous in security relevant applications such as illumination of emergency exits, emergency shut-off switches or the like. To avoid a thermal destruction of the driver circuit, the circuit is deactivated when the temperature exceeds a maximum temperature T_{MAX}. A_{S} long as the temperature remains lower than the maximum temperature T_{MAX} a thermal equilibrium may occur at any point on the curve shown in FIG. 3, dependent on the actual temperature of the driver circuit and the ambient temperature.

The parameters T₁ and T₂ fully determine the characteristic curves. According to one example of the invention these parameters may be set by adjusting the resistance on one external resistor connected to the measurement circuit. As such the curve defined by the temperatures T₁′ and T₂′, T₁″ and T₂″, T₁′″ and T₂′″, and T₁″″ may be chosen (the temperature T₂″″ corresponding to T₁″″ would be higher than T_{MAX} and thus ineffective).

One exemplary measurement circuit that allows an efficient implementation of the measurement circuit is illustrated in FIG. 4. The circuit of FIG. 4 is supplied with a supply voltage V_{S} with respect to a reference potential referred to as ground potential GND in the present circuit. The circuit of FIG. 4 is further provided with an input voltage V_{IN} (corresponds to V_{DRIVEmax} in FIG. 2) that which sets the maximum output voltage V_{DRIVE}(T). Several reference current sources Q₁, Q₂, Q₃, Q₄, and Q₅ are used in the circuit. All these current sources provide fixed multiples of a reference current i_{REF} which is essentially temperature independent. For this purpose a band-gap reference circuit may be used to generate a temperature independent reference current, and all current sources may derive the sourced current from the stable output current of the band-gap reference circuit.

In the present example the temperature dependent forward voltage V_{BE} of a two silicon diodes D₁ and D₂ are used to provide the middle portion of the characteristic curve (between temperatures T₁ and T₂) depicted in FIG. 3. The forward voltage V_{BE} of a diode (this is also valid for the base-emitter-diode of a bipolar transistor) has a temperature coefficient of about −2 mV/° C., that is the voltage V_{BE} drops for about 2 mV as the temperature rises by one degree Celsius. The two diodes D₁ and D₂ are connected in series to a first current source Q₁, which provides a current i_{REF}. The diodes D₁ and D₂ are connected between the supply node at which the supply potential VS is provided and the current source Q₁. The voltage drop 2·V_{BE} across the diodes D₁, D₂ is converted into a temperature dependent current i_{SLOPE} which approximately equals V_{BE}/R₁. For this purpose a bipolar transistor T₁ (pnp type) is provided. The emitter of the transistor T₁ is connected so the supply node via the resistor R₁ (emitter resistor) and the base of the transistor T₁ is connected to the common circuit node of current source Q₁ and diode D₁. As a consequence, the voltage drop across the emitter resistor R₁ is approximately V_{BE} (assuming the base-emitter voltage of transistor T1 is also V_{BE}) and thus the collector current of the transistor T₁ (denoted as i_{SLOPE}) equals V_{BE/}R₁ (assuming the base current of the transistor T₁ is negligible). Therefore the current i_{SLOPE} exhibits the same temperature dependency as the diode forward voltage V_{BE}. In essence the transistor T₁ and the resistor R₁ can be regarded as voltage-to-current converter which converts the temperature dependent forward voltage V_{BE} into a corresponding current i_{SLOPE}.

The current i_{SLOPE} adds to the emitter current i_{ET2} of a second bipolar transistor T₂ (npn type) and the sum current i_{SLOPE}+I_{ET2} is directed through the resistor R₃ to the ground node, at which the ground potential GND is provided. That is, the resistor R3 is connected between the emitter of transistor T₂ and ground. The base of the transistor T₂ is supplied with a base voltage of 2·i_{REF}·R₂+V_{BE}, whereby the current 2·i_{REF} is provided by the second current source Q₂, the voltage V_{BE} is the forward voltage of a further diode D₃. The resistor R₂ is connected in series with the diode D₃ and the current source Q₂ such that the sourced current 2·i_{REF} is mainly (i.e., neglecting the base current of transistor T₂) directed through the diode D₃ and the resistor R₂. The transistor T₂ essentially operates as an emitter follower and thus the emitter voltage V₃ of the transistor T₂ follows essentially the base voltage minus the forward voltage of the base-emitter diode. That is, the emitter voltage V₃ equals approximately the voltage drop across the resistor R₂ and thus V₃=2·i_{REF}·R₂. As a result the emitter current i_{ET2} of the transistor T₂ can be calculated as i_{ET2}=2·i_{REF}·R₂/R₃−i_{SLOPE}. This emitter current i_{ET2} is copied and magnified by a factor 10 using the current minor CM₁. That is, the current minor output current at the circuit node N equals 20·i_{REF}·(R₂/R₃)−10·i_{SLOPE}. The capacitor C₁ coupled to the current minor output node (node N) is used to suppress transient current spikes. In essence, the current mirror CM₁ in combination with the transistor T₂ (and the circuitry for biasing the base of the transistor T₂) and the resistor R₃ can be regarded as subtracting circuit configured to subtract the current i_{SLOPE} from a pre-defined constant current (2·i_{REF}·R₂/R₃).

The first break of slope of the characteristic curve of FIG. 3 at temperature T₁ (temperature threshold) may be set by appropriately choosing the values of the resistors R₁, R₂, and R₃, wherein the steepness of the slope between the temperatures T₁ and T₂ is mainly determined by the value of resistor R₁. The characteristic curve of FIG. 3 may be shifted to the right as illustrated in FIG. 3 by means of the resistors R₄, R₅, and R_{EXT}, which is an external component placed outside the chip, the MOS transistor M₁, the current source Q₄, and the operational amplifier OA₁, particularly by adjusting the resistance of the external resistor R_{EXT}. Accordingly, the current source Q₄ sources a current 5·i_{REF} which is directed through the resistors R₅ and R_{EXT} which are connected in series between the current source Q₄ and the ground node GND. Furthermore, the resistor R₄ is connected between the ground node GND and the source electrode of the MOS transistor M₁, which has a gate electrode that is driven by the output of the operational amplifier OA₁. The operational amplifier OA₁ controls the MOS transistor such that the voltage drops across the resistor R_{EXT} and the resistor R₄ are approximately equal. The resulting drain current passing through the MOS transistor (n-channel type) is denoted as i_{M1}. As such, the terminals of the resistors R_{EXT} and R₄ not connected to ground are connected to the inverting and non-inverting inputs of the operational amplifier OA₁, respectively. As the voltage i_{M1}·R₄=5·i_{REF}·R_{EXT}, it follows that the current i_{M1} equals 5·i_{REF}·R_{EXT}/R₄. The current iM1 is copied and downscaled to the output of the current minor output branch of current minor CM₂. The respective mirror current 0.5·i_{M1}=5·i_{REF}·R_{EXT}/R₄ is also supplied to the circuit node N. As compared to the mirror current (10·i_{ET2}) at the output of the first current mirror CM₁ the minor current (0.5·i_{M1}) does not significantly depend on temperature. In essence the current minor CM₂ in combination with the circuitry providing the input current to the current mirror CM₂ can be regarded as current source providing an offset current (i.e., the minor output current 2·i_{M1}) that can be set using the external resistor R_{EXT}.

The minimum drive voltage V_{DRIVEmin} (see FIG. 3) may be set my appropriately choosing the resistors R₆ and R₇ which are used in combination with the third current mirror CM₃, the MOS transistor M₂ (n-channel type), the current source Q₅, and the operationally amplifier OA₂. The input branch sinks the residual current i_{RES} from circuit node N, whereby another current 2.5·i_{REF} is sunk from node N using current source Q₃. That is, i_{RES} calculates as i_{RES}=10·i_{ET2}+0.5·i_{M1}−2.5·i_{REF}. This residual current i_{RES} is copied and downscaled to the output branch of the current mirror CM₃. A series circuit of current source Q₅ (sourcing a current of 2·i_{REF}), MOS transistor M₂ and resistor R₇ is connected between the supply node (supply voltage V_{S}) and the ground node, wherein the MOS transistor is connected between the resistor R₇ and the current source Q₅, and the resistor R₇ is connected between the MOS transistor M₂ and the ground node. The gate of MOS transistor M₂ is controlled by the operational amplifier OA₂, which receives the input voltage V_{IN} (corresponds to V_{DRIVEmax}) at its non-inverting input and the voltage across resistor R₇ at its inverting input. The output branch of the current mirror CM₃ is connected to the drain of the MOS transistor M₂ via resistor R₆. That is, the resulting drain current of the MOS transistor M₂ is the current 2·i_{REF} provided by the current source Q₅ minus the (mirrored and downscaled) residual current 0.5·i_{RES} which is sunk by the current mirror CM3 via resistor R₆. Thereby the voltage drop across the resistor R₆ is R₆·i_{RES}.

At low temperatures, the current 0.5·i_{RES} sunk by the current mirror CM₃ is low and thus the operational amplifier may regulate the output voltage (drive voltage V_{DRIVE}) to equal the input voltage V_{IN}, while the current source Q₅ operates as a high-impedance active load. As the temperature rises, the current 0.5·i_{RES} sunk by the current minor CM₃ also rises and the operational amplifier saturates and the MOS transistor M2 becomes fully conductive with a low drain-source voltage drop. In this operational state the drive voltage V_{DRIVE} will follow the voltage drop across the resistor R₆ which is temperature dependent. This voltage drop across the resistor R₆ will not exceed the value 0.5·i_{REF}·R₆ (as the current source Q₅ will not deliver more). Thus, the value of R₆ determines the minimum drive voltage V_{DRIVEmin}.

Finally, the comparator K₁ in combination with the further MOS transistor M₃ may be used to deactivate the drive voltage V_{DRIVE} when a maximum temperature T_{MAX} is exceeded (see FIG. 3). The comparator is configured to compare the voltage V_{S}−2·V_{BE} with a reference voltage representing the maximum temperature. In case the voltage V_{S}−2·V_{BE} drops below the reference voltage V_{REF} (at a temperature T_{MAX}) then the MOS transistor, which is controlled by the comparator output, will clamp the output voltage V_{DRIVE} to zero volts.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. It should be mentioned that features explained with reference to a specific figure may be combined with features of other figures, even in those where not explicitly been mentioned. Further, the methods of the invention may be achieved in either all software implementations, using the appropriate processor instructions, or in hybrid implementations that utilize a combination of hardware logic and software logic to achieve the same results. Such modifications to the inventive concept are intended to be covered by the appended claims.

What is claimed is:

1. A semiconductor chip including integrated circuitry, the semiconductor chip comprising:
an LED driver circuit configured to be coupled to an LED to supply a load current to the LED such that an average load current matches a desired current level defined by a drive signal; and
a temperature measurement circuit configured to be thermally coupled to the LED driver circuit or the LED or both to generate, as a drive signal, a temperature dependent signal in such a manner that the drive signal
is approximately at a higher constant level for temperatures below a first temperature,
is approximately at a lower constant level for temperatures above a second temperature but below a maximum temperature, and
continuously drops from the higher constant level to the lower constant level for temperatures rising from the first temperature to the second temperature.

2. The semiconductor chip of claim 1, wherein the temperature measurement circuit is further configured to shut down the LED driver circuit when the temperature reaches or exceeds the maximum temperature.

3. The semiconductor chip of claim 1, further comprising a pin for externally connecting a resistor of a defined resistance, wherein the temperature measurement circuit is configured to be operably coupled to the resistor and wherein the first and the second temperatures are determined by the resistance.

4. The semiconductor chip of claim 1, further comprising a modulator configured to receive the drive signal and to provide an on/off modulated signal having a duty cycle corresponding to the desired current level.

5. The semiconductor chip of claim 1, wherein the temperature measurement circuit includes a forward biased silicon diode having a forward voltage with a negative temperature coefficient.

6. The semiconductor chip of claim 5, wherein the temperature measurement circuit includes a voltage-to-current-converter coupled to the silicon diode to generate a temperature dependent current representing the forward voltage of the silicon diode.

7. The semiconductor chip of claim 6, wherein the temperature measurement circuit includes a subtracting circuit configured to provide a difference current substantially equal to a pre-defined constant current minus the temperature dependent current representing the forward voltage of the silicon diode.

8. The semiconductor chip of claim 7, further comprising
a pin configured to be externally connected to a resistor of a defined resistance; and
a current source configured to generate an offset current that depends on the resistance of the externally connected resistor.

9. The semiconductor chip of claim 8, in which the offset current and the difference current superpose in a circuit node resulting in a residual current that depends on temperature.

10. The semiconductor chip of claim 9, further comprising:
a further current source configured to generate a substantially constant current, wherein a current proportional to the residual current is subtracted from the substantially constant current;
a transistor coupled in series to the current source such that a first portion of the substantially constant current can pass through the transistor;
a resistor coupled in series to the transistor, wherein a voltage drop across the resistor forms the drive signal; and
an operational amplifier having an output coupled to the control electrode of the transistor and configured to provide a control signal to the transistor representing the difference between the drive signal and an input signal.

11. An apparatus comprising:
an LED;
semiconductor chip including integrated circuitry, the semiconductor chip comprising:
an LED driver circuit coupled to an LED to supply a load current to the LED such that an average load current matches a desired current level defined by a drive signal;
a temperature measurement circuit thermally coupled to the LED driver circuit or the LED or both to generate, as a drive signal, a temperature dependent signal in such a manner that the drive signal
is approximately at a higher constant level for temperatures below a first temperature,
is approximately at a lower constant level for temperatures above a second temperature but below a maximum temperature, and
continuously drops from the higher constant level to the lower constant level for temperatures rising from the first temperature to the second temperature.

12. The apparatus of claim 11, wherein the temperature measurement circuit is further configured to shut down the LED driver circuit when the temperature reaches or exceeds the maximum temperature.

13. The apparatus of claim 11, further comprising an external transistor having a defined resistance and coupled to the semiconductor chip, wherein the temperature measurement circuit is operably coupled to the resistor and wherein the first and the second temperatures are determined by the defined resistance.

14. The apparatus of claim 11, wherein the semiconductor chip further comprises a modulator configured to receive the drive signal and to provide an on/off modulated signal having a duty cycle corresponding to the desired current level.

15. The apparatus of claim 11, wherein the temperature measurement circuit includes a forward biased silicon diode having a forward voltage with a negative temperature coefficient.

16. The apparatus of claim 15, wherein the temperature measurement circuit includes a voltage-to-current-converter coupled to the silicon diode to generate a temperature dependent current representing the forward voltage of the silicon diode.

17. The apparatus of claim 16, wherein the temperature measurement circuit includes a subtracting circuit configured to provide a difference current substantially equal to a pre-defined constant current minus the temperature dependent current representing the forward voltage of the silicon diode.

18. The apparatus of claim 17, further comprising an external resistor of a defined resistance coupled to the semiconductor chip, wherein the semiconductor chip further comprises a current source configured to generate an offset current that depends on the resistance of the resistor.

19. The apparatus of claim 18, in which the offset current and the difference current superpose in a circuit node resulting in a residual current that depends on temperature.

20. The apparatus of claim 19, wherein the semiconductor chip further comprises:
a further current source configured to generate a substantially constant current, wherein a current proportional to the residual current is subtracted from the substantially constant current;
a transistor coupled in series to the current source such that a first portion of the substantially constant current can pass through the transistor;
a resistor coupled in series to the transistor, wherein a voltage drop across the resistor forms the drive signal; and
an operational amplifier having an output coupled to the control electrode of the transistor and configured to provide a control signal to the transistor representing the difference between the drive signal and an input signal.
